(19) United States
(12) Patent Application Publication
(10) Pub. No.: US 2003/0012016 A1
(43) Pub. Date: Jan. 16, 2003

(54) Protective tube having light convergent flash lamp

(76) Inventor: Chun-Teng Lee, Taipei City (TW)

Correspondence Address: LEE, CHUN-TENG, P.O. BOX 7-820, TAIPEI, TW

(21) Appl. No.: 09/905,822

(22) Filed: Jul. 16, 2001

(51) Int. Cl. F21S 6/00

(52) U.S. Cl. 362/124; 362/363; 362/806; 362/551; 362/808

(57) ABSTRACT

This invention relates to a protective tube having a light convergent flash lamp, wherein a protruded legs is integrally disposed at the end of the tube for embedding the covering ring in the grooves, such that the protruded legs locates just above the light source of the flash lamp, and the end side of the bulb shell is fused with the glass bulb collecting the light an the arc angle to reflect the light towards the protruded legs. The protruded legs guides the light energy to the entire tube and put the light effect into full play. Special interesting patterns at the upper section of the tube gives excellent viewing effect. This invention keeps a suitable distance between the diameter of the tube and the flash lamp to prevent them from being damaged due to transportation or collision. This invention is characterized that it guides the light with interesting patterns and also has the function of protecting the light bulb.

### BACKGROUND OF THE INVENTION

1. Field of the Invention

This invention is related to a protective tube with light convergent flash lamp, which mainly consists of a set of protruded legs at the base of the tube for embedding into the grooves provided on the ring of the covering plate, so that the protruded legs will be positioned just above the light bulb which is the light source, and converging the light through the curvature of the flash lamp towards the protruded legs, then by way of the protruded legs, rendering the illumination of the entire protective tube, and produce interesting visual lighting effect with the special interesting patterns at the upper section of the tube. A suitable distance between the protective tube and the flash lamp prevents damage during transportation or from collision. This invention is uniquely characterized by its dual benefits of producing an interesting visual lighting effect in a special and interesting pattern, as well as offering protection for light bulbs.c

2. Description of he Prior Art

As technology progresses from day to day, maximum utility of products is always a desired objective, therefore it is necessary to incorporate innovation and safety in application of product functions in order to meet the needs, and win the purchase willingness of consumers. Because decorative lighting have generally been used at night, therefore they have traditionally emphasized luminescence and color variety, whose functional benefits understandably were simply to fill the night sky with dizzying brightness and colors. Furthermore, traditional lighting adopts the open style of design, where there is only a single layer of glass separating the source of illumination from external forces. When external force is exerted accidentally or when there is a significant temperature change, it possesses the danger of explosion or cracking. In addition, relying on traditional light bulbs for general lighting function is the way of the past, and is out of step with the needs of the modern era, which is forever demanding for something new and something different. One needs to promptly adapt the objectives in keeping with trends, in order to fulfill the needs of the consumers in the general public.

In view of the shortcomings and inconvenience of the prior art mentioned above, which are the subjects of improvements for a long time, hence the inventor of this invention based on years of experience accumulated from the engagement in the related industry conducted extensive research to resolve the foregoing shortcomings and invented the present invention.

### SUMMARY OF THE INVENTION

The main object of the present invention is to provide a protective tube with a light convergent flash lamp, within particular reference to the combined utilization of a tube, a flash lamp, a covering plate, a light bulb, and a lamp, characterized in its dual benefits of producing an interesting visual lighting effect in a special and interesting pattern, as well as offering protection for light bulbs.

The secondary objective of this invention is to provide a protective tube having a light convergent flash lamp, which keeps a suitable distance between the protective tube and the flash lamp to prevent damage during transportation or from collision.c

### BRIEF DESCRIPTION OF THE DRAWINGS

FIG. 1 is a perspective view of the present invention.

FIG. 1 shows the assembled structure of a preferred embodiment of this invention.

FIG. 2 is a perspective exploded view of the present invention.

FIG. 2 shows the three-dimensional assembled parts according to this invention.

FIG. 3 shows a preferred embodiment of the tube according to this invention.

FIG. 4 shows the protruded legs passing through the light bulb's arc light guiding tube according to a preferred embodiment of this invention.

FIG. 5 shows the protective function of separating the tube and the inner tube with an appropriate distance according to this invention.

### DETAILED DESCRIPTION OF THE PREFERRED EMBODIMENT

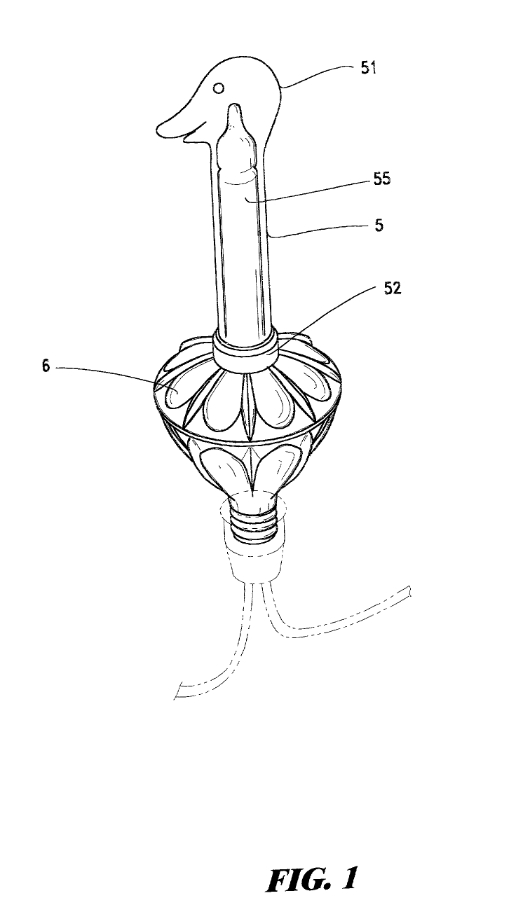

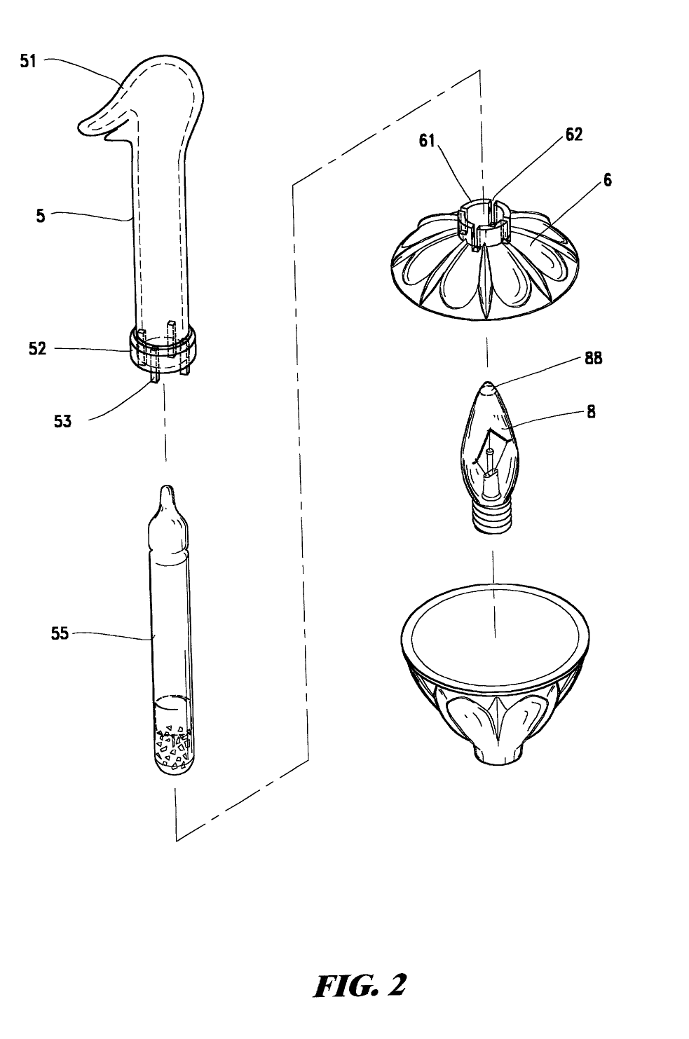

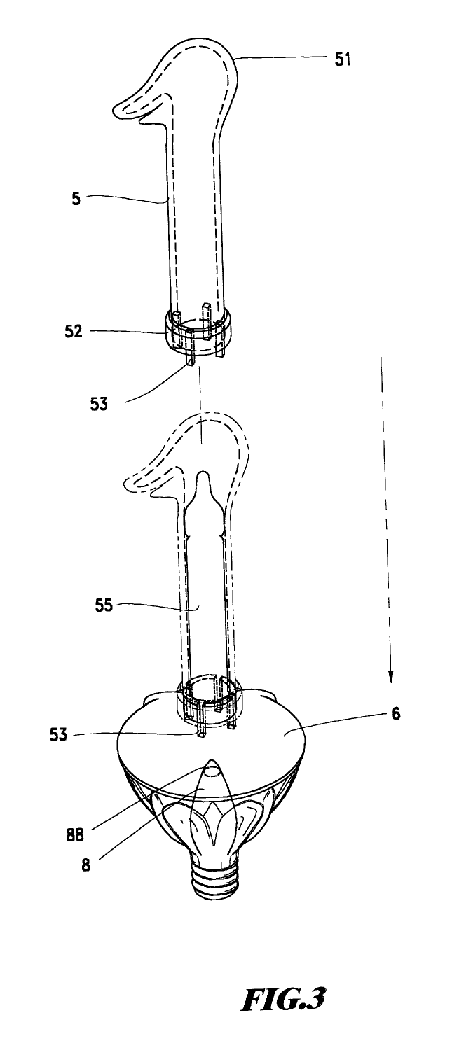

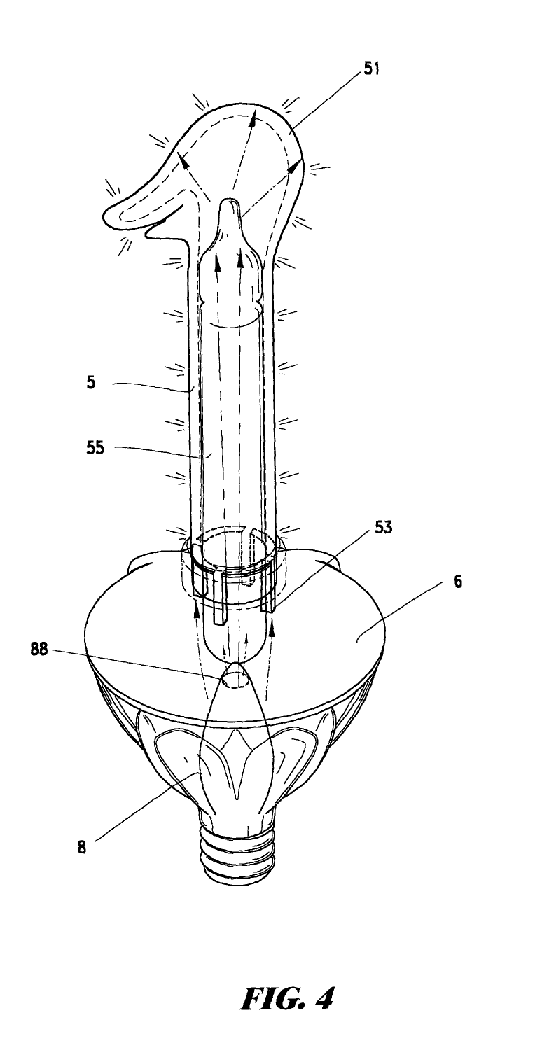

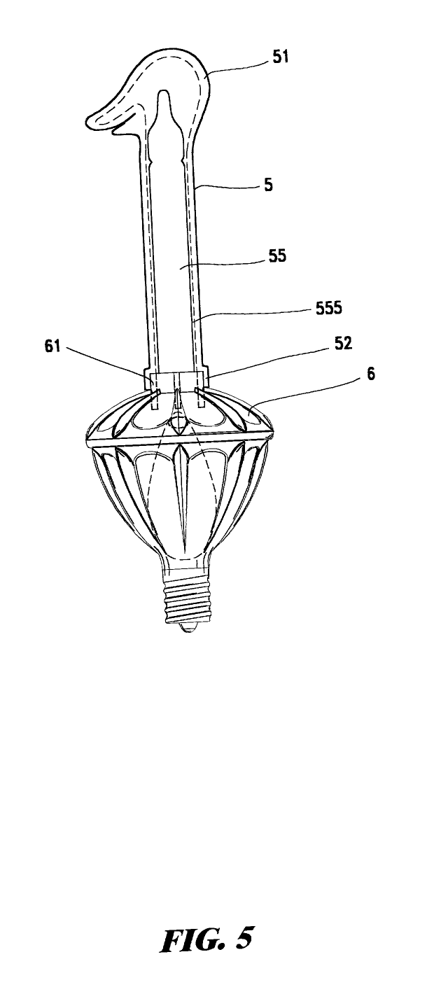

Please With reference to the drawings and in particular to FIGS. 1 through 5, which show a protective tube having a light convergent flash lamp comprising a tube, a flash lamp, a covering plate, a light bulb, and a lamp base; characterized in that a tube (FIG. 5) can be placed over a flash lamp tube (FIG. 55), but separated by a distance between the two, and a special interesting pattern is designed on the external shell (FIG. 51) at the upper section of the tube, and an external ring (FIG. 52) being located at the end of the tube that couples to the covering plate. A set of protruded legs (FIG. 53) is respectively coupled to the interior of the external ring (FIG. 52) and embedded into the grooves at the center of the covering plate, and the covering plate (FIG. 6) is a circular plate, which integrally couples to an inner ring hole (FIG. 61) in the middle, and a set of grooves (FIG. 62) are evenly positioned around the periphery of the ring. A set of evenly positioned grooves are aligned to the upper section of the lower edge of the light bulb (FIG. 8), the light bulb, and the top of the bulb shell (FIG. 8) to fuse an arc angled sphere (FIG. 88) in a reverse direction in order to collect the reverse reflection of the light source from the light bulb.

This invention constitutes a practical implementation by placing a tube over a flash lamp, and aligning and embedding the evenly distributed protruded legs on the outer periphery at an end of the tube to the evenly distributed grooves on the ring in the center of the covering plate. The protruded legs are located above the position that surrounds the lower light bulb, and the outer ring of the tube is fixed to the inner ring in the covering plate. The upper section of the tube is fused to the tube and fixed in that position so that it will not shake and in the meantime the light guided by the protruded legs will not vibrate. The light is reflected from the arc spherical object at the top of the light bulb to the protruded legs such that the light source above the protruded legs is guide to reflect to the entire tube and put the lighting in full play. By means of an interesting pattern design on the shell, it shows an excellent visual effect. The diameter of the tube offers an effect of preventing the light bulb and the tube from being damaged. Therefore this invention can transmit a light with interesting decorative design and also can protect the flash lamp.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

I claim:

1. A protective tube having a light convergent flash lamp, comprising a tube, a flash lamp, a covering plate, a light bulb, and a lamp base; wherein:
the tube, for receiving the flash lamp and keeping an appropriate distance from the tube of the flash lamp, and an external ring of the covering plate can be mounted to the end of the tube having a patterned shell, and the external ring having a set of protruded legs being evenly distributed around the periphery of the outer ring for aligning with the corresponding grooves at the middle of the covering plate;
the covering plate, a plate member integrally having an inner ring at its center, and a set of grooves being evenly distributed around the periphery of the ring which are aligned to the upper section of the lower edge of the light bulb;
the light bulb, having its top fused in reverse direction with an arc spherical member so that the light source of the light bulb can be guided and reflected;
such arrangement can transmit and collect the light with interesting patterns and also can protect the flash lamp.

2 A protective tube having a light convergent flash lamp according to claim 1, wherein said tube having the protruded legs at one of its ends embedded into the grooves of the covering plate, thereby the protruded legs locates above the light source of the light bulb, and the end side of the bulb shell being fused with a glass shell and the light is collected and reflected towards the legs, and reflects the light to the entire tube that puts the lighting in full play, and gives a viewing effect with interesting patterns at the upper section of the tube.

3 A protective tube having a light convergent flash lamp according to claim 1, wherein said tube having a diameter such that the tube and the flash lamp are kept in an effective distance to prevent the flash lamp being damaged due to transportation and collision.
